(19) United States
(12) Patent Application Publication
(10) Pub. No.: US 2005/0263095 A1
(43) Pub. Date: Dec. 1, 2005

(54) Apparatus for exercising animals

(76) Inventor: Arno Inauen, Schwanden (CH)

Correspondence Address: Richard S. Shenier, 1077 Northern Boulevard, Roslyn, NY, 11576, US

(21) Appl. No.: 11/115,126

(22) Filed: Apr. 27, 2005

(30) Foreign Application Priority Data
May 5, 2004 (DE) 20 2004 007 167.3

(51) Int. Cl. A01K 15/02

(52) U.S. Cl. 119/704

(57) ABSTRACT

The apparatus has a circulating moveable cable. The cable runs around a drive cable pulley and a guide cable pulley. Several gates are suspended from the cable. These gates are mounted to the cable by coupling units. In operation the gates abut the horses from behind and induce the animals to walk forwards.

### CROSS REFERENCE TO RELATED APPLICATION

Applicant Claims Priority under 35 U.S.C. Section 119 of German Application 20 2004 007 167.3, Filed May 5, 2004.

### BACKGROUND OF THE INVENTION

1. Field of the Invention

The present invention relates to a apparatus for walking specifically horses, having a plurality of moveable movement inducing units adapted to act onto the animals in order to cause these animals to move forwards, which movement inducing units are coupled to a conveying apparatus.

2. Description of the Prior Art

It is generally known that for instance horses should not be let to stand for a prolonged time space relatively unmovable in a stable because when standing such a long time in the same place their physical health will be impaired.

In order to counter such a situation apparatuses for walking for instance horses have been developed which conventionally are designed as a carousel and have a wheel with a large diameter and a vertical axis. The horses to be moved, that is walked are coupled to the wheel and the wheel is thereafter made to rotate so that the horses walk along a circular path, that is, must walk. It is also possible to have gate-like guiding grids mounted to such a wheel. Such horse walking apparatuses are disclosed e.g. by the DE-A-28 52 777, DE-C-39 35 142, DE-C-197 46 562 and U.S. Pat. No. 6,694,919. The EP-B-0 146 604 discloses a training course for animals in which mobile units move along a rigid guide.

Due to the continuous walking of the animals along a circular path the joints of the legs will be, however, continuously strained in a non-uniform manner which leads to a damages of the physical health. A training course with guides and individual mobile units is quite intricate and costly.

### SUMMARY OF THE INVENTION

Hence, it is a general object of the invention to provide a apparatus for walking specifically horses which allows a largely uniform loading of the joints.

A further object of the invention is to provide a apparatus for walking specifically horses which comprises a circulating moveable cable which is supported by at least two cable pulleys located of a distance from each other, which movement inducing units are coupled b means of respective coupling units to the cable which is adapted to serve as supporting means and also as driving means for mentioned movement inducing units, and of which cable pulleys at least one is connected to and adapted to be driven by the drive motor.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a simplified perspective view of a horse walking apparatus according to the invention;

FIG. 2 is a side view of the horse walking apparatus illustrated in FIG. 1;

FIG. 3 is a top view of the horse walking apparatus illustrated in FIG. 1, without the building;

FIG. 4 is a cross-section through the horse walking apparatus illustrated in FIG. 1 with the building;

FIG. 5 is a section through the clamping means of the coupling unit;

FIG. 6 is a view of a guide-like designed gate;

FIG. 7 illustrates a detail of the drive of a cable pulley;

FIG. 8 is a simplified view of a tensioning device of a cable pulley; and

FIG. 9 illustrates cable supporting rollers arranged in a rocker.

### DETAILED DESCRIPTION OF THE PREFERRED EMBODIMENT

The conveying apparatus of the illustrated horse walking apparatus comprises basically a circulating cable 1. This cable 1 is supported by two cable pulleys located at a distance from each other, namely a drive cable pulley 2 and a guide cable pulley 3.

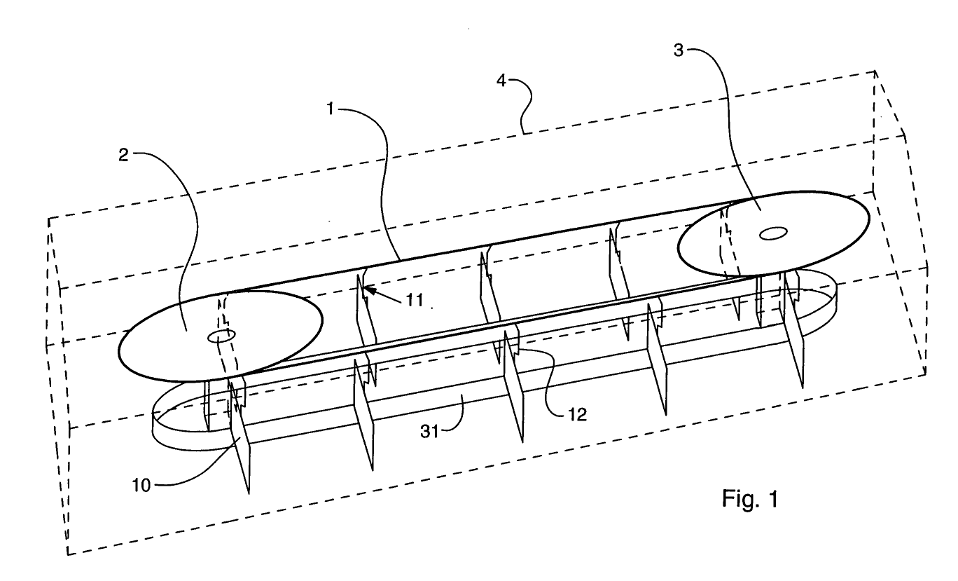

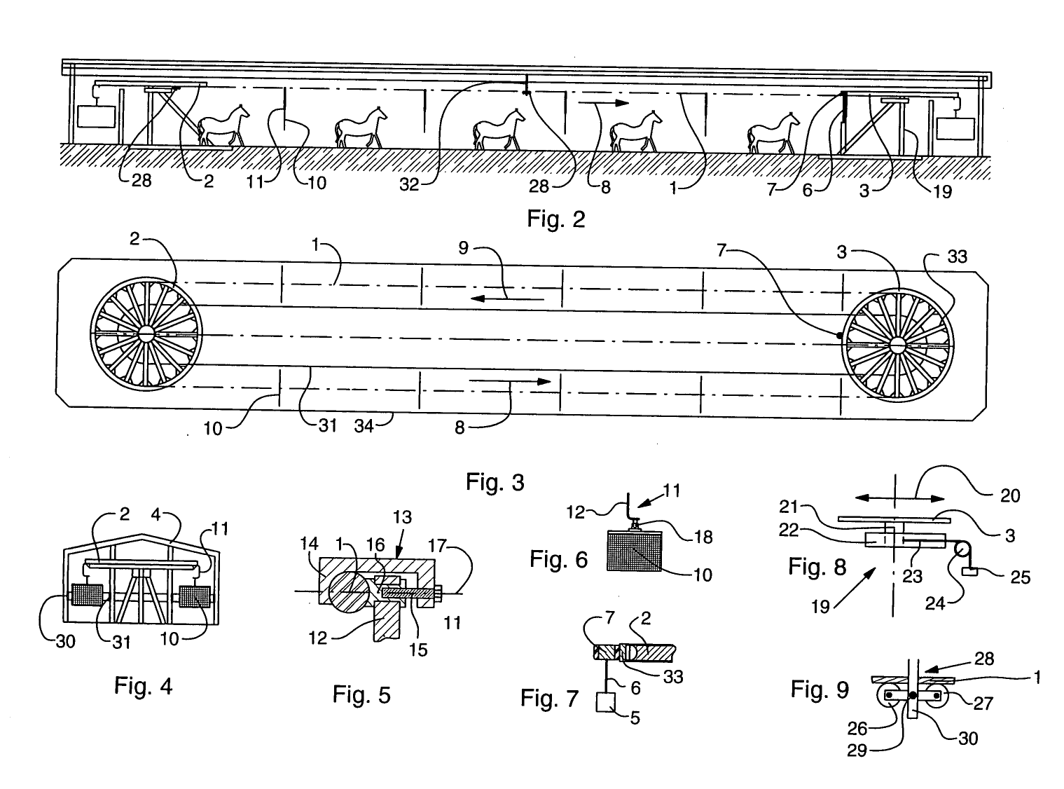

A building 4 is indicated in FIG. 1 by broken lines, see hereto FIG. 4, in which building the above-mentioned components are located.

The drive cable pulley 2 is driven by a motor 5, it could be driven by various drive transmitting members; in the preferred embodiment. The drive shaft 6 of the motor 5 is mounted to a wheel 7 having a tire (FIG. 7). The drive cable pulley 3 has a outer circumferential ring 33. The tire wheel 7 about this outer circumferential ring 33 is thus in a frictional engagement with the outer circumferential ring 33, conclusively the drive cable pulley 2 is driven by the motor 5 wherewith the cable 1 is moved in a circulating manner. The direction of movement of the cable 1 is identified for the one of its section by the arrow 8 and for the other one by the arrow 9.

Several movement inducing means in form of a grid-like gate 10 are suspended from the cable 1. These gates 10 are connected through coupling units 11 to the cable 1.

Each coupling unit 11 includes a C-shaped bracket portion 12. A claming device 13 is arranged at the end of the bracket portion 12 located adjacent the cable 1. This clamping device 13 has a first clamping plate 14 which can be moved by a threaded clamping bolt 15 against a second clamping plate 16 so that the cable 1 is clamped between the two clamping plates 15, 16. The C-shaped bracket portion 12 is pivotally mounted to the second clamping plate 16 and rotatable in a direction perpendicularly to the direction of movement 8 and 9, respectively of the cable 1.

The gates 10 are pivotally mounted through a pivot pin 18 to the C-shaped bracket portion 12 at the end of the coupling unit 11 remote from the cable 1. The pivot axis of the pivot pin 18 extends in the direction of movement 8 and 9, respectively of the cable 1.

The guide cable pulley 3 is supported in a supporting frame 19 displaceable in a direction 20 which coincides with the direction of movement 8 and 9, respectively of the cable 1. To this end the guide cable pulley 3 is supported in a sliding block 21 which is arranged in a track-like fashion in a elongate supporting beam 22.

The sliding block 21 is connected to a cable 23 which runs around a cable pulley 24 and carries a weight 25. By means of this weight 25 the cable 1 is held taut. The tension of the cable 1 can be adjusted by a adding or removing of individual weight units.

It is to be noted that the illustration in FIG. 8 is extremely simplified, because the cable 23 could be placed around several further (not illustrated) cable pulleys or guide pulleys.

The cable 1 is additionally supported by supporting rollers 26, 27. Several pairs of such cable supporting rollers 26, 27 are installed, whereby every supporting roller pair 26, 27 is arranged in a rocker 28. Every rocker 28 is supported in a support 30 in a manner that it can rotate around a rocker axis 29 extending perpendicularly to the direction of movement 8 and 9, respectively of the cable 1.

The apparatus comprises thus a horse walking path which is determined by the course of the cable 1. Walking path defining belts 31, 34 are arranged at both sides of this walking path, in order to keep the horses from sideways deviating from this walking path.

The gate 10 is of a grid-like design. As grid a grid composed of metal wires can be used, which wires are connected to a source of a electrical discharge, so that, when necessary and analogue to enclosures of cow pastures by electrically charged wires, a horse can be incited to walk.

The embodiment described and illustrated in the Figures includes only two cable pulleys 2, 3. However, also designs having three, four or more pulleys are foreseen, so that a apparatus with quite large dimension is possible, so that a given walkway caw have a length of several 100 meters. Such a walkway can be of a arbitrary shape, e.g. in case of three cable pulleys of a triangular shape or with four cable pulleys of a square shape.

While there is shown and described a present preferred embodiment of the invention, it is to be distinctly understood that the invention is not limited thereto but may be otherwise variously embodied and practiced with the scope of the claims. Thus, the disclosed apparatus can also be applied e.g. for walking racing camels.

1. Apparatus for exercising animals having a plurality of moveable movement inducing units adapted to act onto the animals in order to cause the animals to move forwards, which movement inducing units are coupled to a conveying apparatus, wherein said conveying apparatus comprises a circulating moveable cable which is supported by at least two cable pulleys located at a distance from each other, further wherein said movement inducing units are coupled by means of respective coupling units to said cable which is adapted to serve as supporting means and also as driving means for said movement inducing units, and wherein at least one of said cable pulleys is connected to and adapted to be driven by said drive motor.

2. The apparatus of claim 1, wherein each movement inducing unit is designed as a grid-like gate.

3. The apparatus of claim 2, wherein each coupling unit comprises at its end located at said cable a clamping means by means of which said coupling unit is attached to said cable in a clamped state, and comprises a C-shaped bracket portion which is pivotally mounted to said clamping means for rotation around a axis extending perpendicularly to a direction of movement of said cable, and wherein said gate is mounted to said C-shaped bracket portion at an end of said coupling unit remote from said cable.

4. The apparatus of claim 2, wherein each gate is mounted through a pivot pin having a pivot axis extending perpendicularly to a direction of movement of said cable to an end of coupling unit remote from said cable.

5. The apparatus of claim 1, wherein the cable pulley connected to said drive motor comprises a outer circumferential ring and said drive motor comprises a drive shaft connected to a wheel having a tire which frictionally engages said outer circumferential ring.

6. The apparatus of claim 1, wherein one of said cable pulleys is supported in a supporting frame which is displaceable in a direction of movement of said cable and is coupled to a tensioning device adapted to keep said cable tensioned.

7. The apparatus of claim 1, comprising further a plurality of supporting rollers which are supported in pairs for rotation in rockers having a rocking axis extending perpendicularly to a direction of movement of said cable.

8. The apparatus of claim 1 and including a set animal walking path determined by the course of said cable, comprising animal walking path defining belts extending along both sides of said walking path and adapted to prevent animals from a deviating s from said path.

9. Apparatus for exercising an animal around a circuit comprising a continuous path having alternate turns and straightaways, there being at least two turns and two straightaways, including or in combination at least two pulley-like members each rotatable in a generally horizontal plane and a continuous elongated flexible member engaging said pulley-like members, each pulley-like member having at least a lower flange providing vertical support for said flexible member.

10. Apparatus as in claim 9, further including a plurality of spaced elements suspended from the flexible member.

11. Apparatus as in claim 10, wherein each element comprises an electrified conductor.

12. Apparatus as in claim 9, further including means for controlling tension in the flexible member.

13. Apparatus as in claim 9, further including means disposed intermediate two of the pulley-like members for providing vertical support for the flexible member to reduce sag thereof for a given tension therein.

14. Apparatus as in claim 13 wherein the vertical support means comprises an auxiliary pulley engaging the flexible member and rotatable in a generally vertical plane.

15. Apparatus as in claim 13 wherein the vertical support means comprising a pair of closely-spaced auxiliary pulleys mounted on a rocker.

16. Apparatus as in claim 9 further including means for driving the flexible member in at least one direction along said path.

17. Apparatus as in claim 9 further including meeting for driving the flexible member at, at least, one speed along said path.
